(19) United States
(12) Patent Application Publication
(10) Pub. No.: US 2024/0235684 A1
(43) Pub. Date: Jul. 11, 2024

(54) OPTICAL AMPLIFICATION DEVICE AND OPTICAL AMPLIFICATION METHOD

(71) Applicant: NEC Corporation, Tokyo (JP)

(72) Inventor: Yusuke SASAKI, Tokyo (JP)

(73) Assignee: NEC Corporation, Tokyo (JP)

(21) Appl. No.: 18/398,461

(22) Filed: Dec. 28, 2023

(30) Foreign Application Priority Data
Jan. 6, 2023 (JP) 2023-001061

(51) Int. Cl. H04B 10/291; G02B 6/02; H04B 10/25

(52) U.S. Cl. CPC H04B 10/2912; G02B 6/02042; H04B 10/25

(57) ABSTRACT

In an optical amplification device using a multicore optical fiber, it is difficult to efficiently amplify signal light. In order to solve this problem, an optical amplification device according to the present disclosure includes an optical fiber amplification unit including a plurality of amplification cores, a first connection unit being connected to one end of the optical fiber amplification unit, and a second connection unit being connected to another end of the optical fiber amplification unit, wherein the first connection unit is configured in such a way as to connect a transmission fiber including a plurality of transmission cores to the optical fiber amplification unit, and the number of the plurality of amplification cores is larger than the number of the plurality of transmission cores.

This application is based upon and claims the benefit of priority from Japanese Patent Application No. 2023-001061, filed on Jan. 6, 2023, the disclosure of which is incorporated herein in its entirety by reference.

### TECHNICAL FIELD

The present disclosure relates to an optical amplification device and an optical amplification method, and relates particularly to an optical amplification device and an optical amplification method that use a multicore optical fiber.

### BACKGROUND ART

Due to rapid expansion or the like of mobile traffic and a video service, expansion of communication capacity in a core network is required. The requirement for capacity expansion has a tendency to continue in the future as well. Expansion of communication capacity has been conventionally achieved by using a time division multiplexing technique and a wavelength division multiplexing technique. The time division multiplexing technique and the wavelength division multiplexing technique have been applied to an optical communication system with a single-core optical fiber.

In order to further expand communication capacity, a spatial division multiplexing technique being a multiplexing technique employing a dimension different from a conventional multiplexing technique has been developed. For the spatial division multiplexing technique, there are a multicore fiber technique of increasing the number of cores per optical fiber, and a multimode fiber technique of increasing the number of propagation modes. Each of the number of cores and the number of modes being used in current optical fiber communication is one. Thus, it is possible to drastically expand communication capacity by increasing the number of cores and the number of modes.

As optical amplification methods using a multicore optical fiber amplifier, there are two methods: a core excitation method and a clad excitation method. The core excitation method needs an individual light source for each core, but is capable of adjusting gain for each core. Since the clad excitation method amplifies all cores by use of a common excitation light source in a clad, achievement of space saving can be expected.

One example of an optical amplifier with such a clad excitation method is described in PTL 1 (Japanese Patent Application Laid-open Publication No. 2017-183564).

### SUMMARY

A multicore optical fiber amplifier of a clad excitation method such as an optical fiber amplifier described in PTL 1 improves power efficiency of excitation light per core as the number of cores of a multicore optical amplification fiber is larger. This is because, when the number of cores is increased, a ratio of the core area becomes larger in a clad.

Meanwhile, a multicore optical fiber for transmission is used for long-distance transmission and therefore its inter-core distance needs to be large in order to suppress crosstalk, and is preferred to have the same cladding diameter as that of a single-mode optical fiber. Thus, there is a limit in increasing the number of cores of a multicore optical fiber for transmission.

Herein, when the number of cores of a multicore optical fiber amplifier is decreased according to the number of cores of the multicore optical fiber for transmission, power utilization efficiency of excitation light in the multicore optical fiber amplifier is reduced.

In this way, an optical amplification device using a multicore optical fiber amplifier has a problem that it is difficult to efficiently amplify signal light.

An object of the present disclosure is to provide an optical amplification device and an optical amplification method that solve an issue, being the issue described above, that it is difficult for an optical amplification device using a multicore optical fiber to efficiently amplify signal light.

An optical amplification device according to the present disclosure includes: an optical fiber amplification unit including a plurality of amplification cores; a first connection unit being connected to one end of the optical fiber amplification unit; and a second connection unit being connected to another end of the optical fiber amplification unit, wherein the first connection unit is configured in such a way as to connect a transmission fiber including a plurality of transmission cores to the optical fiber amplification unit, and the number of the plurality of amplification cores is larger than the number of the plurality of transmission cores.

An optical amplification method according to the present disclosure includes: receiving signal light propagating through a plurality of transmission cores; and introducing the signal light into a plurality of amplification cores, wherein the number of the plurality of amplification cores is larger than the number of the plurality of transmission cores, the plurality of amplification cores include a first amplification core group and a second amplification core group, and the signal light are caused to propagate through the first amplification core group and the second amplification core group.

An optical amplification device and an optical amplification method according to the present disclosure can efficiently amplify signal light in an optical amplification device using a multicore optical fiber.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an optical amplification device according to a first example embodiment of the present disclosure;

FIG. 2 is a flowchart for describing an optical amplification method according to the first example embodiment of the present disclosure;

FIG. 3 is a block diagram illustrating a configuration of an optical amplification device according to a second example embodiment of the present disclosure;

FIG. 4 is a block diagram illustrating another configuration of the optical amplification device according to the second example embodiment of the present disclosure;

FIG. 5 is a flowchart for describing an optical amplification method according to the second example embodiment of the present disclosure;

FIG. 6 is a block diagram illustrating a configuration of an optical amplification device according to a third example embodiment of the present disclosure; and

FIG. 7 is a flowchart for describing an optical amplification method according to the third example embodiment of the present disclosure.

### EXAMPLE EMBODIMENT

Example embodiments according to the present disclosure are described below with reference to the drawings.

### First Example Embodiment

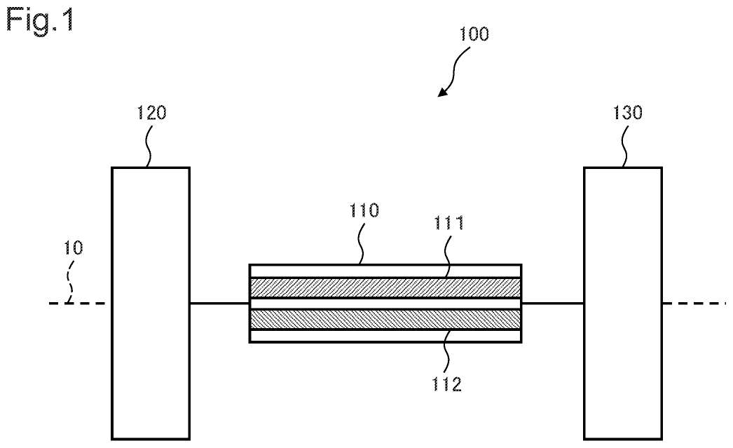

FIG. 1 is a block diagram illustrating a configuration of an optical amplification device 100 according to a first example embodiment of the present disclosure.

The optical amplification device 100 includes an optical fiber amplification unit (optical fiber amplification means) 110, a first connection unit (first connection means) 120, and a second connection unit (second connection means) 130.

The optical fiber amplification unit 110 includes a plurality of amplification cores. The first connection unit 120 is connected to one end of the optical fiber amplification unit 110. Then, the second connection unit 130 is connected to another end of the optical fiber amplification unit 110. In addition, the first connection unit 120 is configured in such a way as to connect a transmission fiber 10 including a plurality of transmission cores to the optical fiber amplification unit 110. Herein, the number of the plurality of amplification cores is larger than the number of the plurality of transmission cores.

In this way, since the optical fiber amplification unit 110 includes amplification cores larger in number than transmission cores in the optical amplification device 100 according to the present example embodiment, power efficiency of excitation light per core can be improved. In other words, the optical amplification device 100 according to the present example embodiment can efficiently amplify signal light in an optical amplification device using a multicore optical fiber.

The optical fiber amplification unit 110 can have a configuration including a multicore optical fiber that includes a plurality of amplification cores doped with a rare-earth ion, and a double-clad structure. As the optical fiber amplification unit 110, a multicore erbium doped fiber (MC-EDF) doped with an erbium ion as a rare-earth ion can be typically used.

The transmission fiber 10 is a multicore optical fiber including, for example, four transmission cores. In this case, the optical fiber amplification unit 110 can have a configuration with a multicore erbium doped fiber including, for example, 8 amplification cores. However, the numbers of transmission cores and amplification cores are not limited thereto.

The first connection unit 120 and the second connection unit 130 can each have a configuration with a fan-in/fan-out connection unit. As the fan-in/fan-out connection unit, fiber bundle type fan-in/fan-out or melt-stretching type fan-in/fan-out can be used. Alternatively, space optics type fan-in/fan-out or planer light wave circuits type fan-in/fan-out may be used.

A plurality of amplification cores can include a first amplification core group 111 and a second amplification core group 112. In this instance, the first connection unit 120 and the second connection unit 130 are configured in such a way that a plurality of pieces of signal light received by the first connection unit 120 propagate through the first amplification core group 111 and the second amplification core group 112. With such a configuration, a plurality of pieces of signal light can propagate through not only the first amplification core group 111 but also the second amplification core group 112. Thus, since amplification cores larger in number than transmission cores can be used for amplification of signal light, signal light can be efficiently amplified.

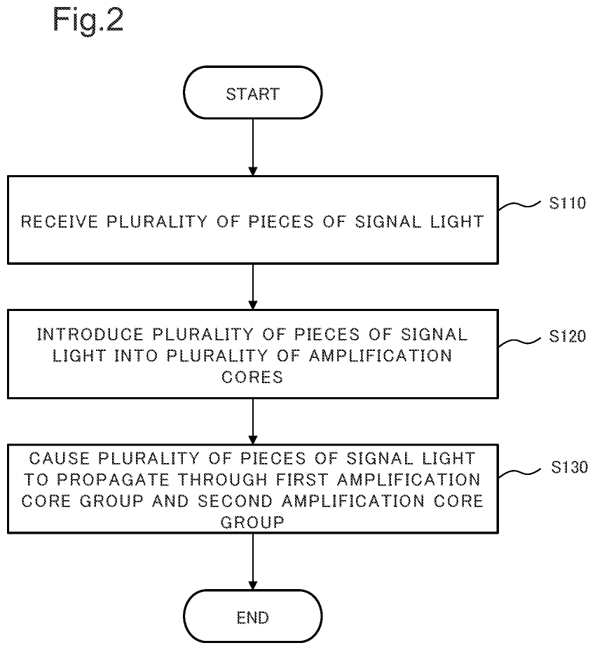

Next, an optical amplification method according to the present example embodiment is described by use of a flowchart illustrated in FIG. 2.

In the optical amplification method according to the present example embodiment, first, a plurality of signal light that has propagated through a plurality of transmission cores is received (step S110). Subsequently, the plurality of signal light is introduced into a plurality of amplification cores (step S120). Herein, the number of the plurality of amplification cores is larger than the number of the plurality of transmission cores. In addition, the plurality of amplification cores includes a first amplification core group and a second amplification core group. Then, the plurality of signal light propagates through the first amplification core group and the second amplification core group (step S130).

Note that, as for step S110, for example, the first connection means serves as an actor. As for step S120, for example, the first connection means serves as an actor. As for step S130, for example, the first connection means and the second connection means serve as actors.

In this way, since the optical amplification method according to the present example embodiment has a configuration that introduces signal light into amplification cores larger in number than transmission cores, power efficiency of excitation light per core can be improved. In addition, a plurality of signal light propagates through not only the first amplification core group but also the second amplification core group. Thus, since amplification cores larger in number than transmission cores can be used for amplification of signal light, signal light can be efficiently amplified.

As described above, the optical amplification device 100 and the optical amplification method according to the present example embodiment can efficiently amplify signal light in an optical amplification device using a multicore optical fiber.

### Second Example Embodiment

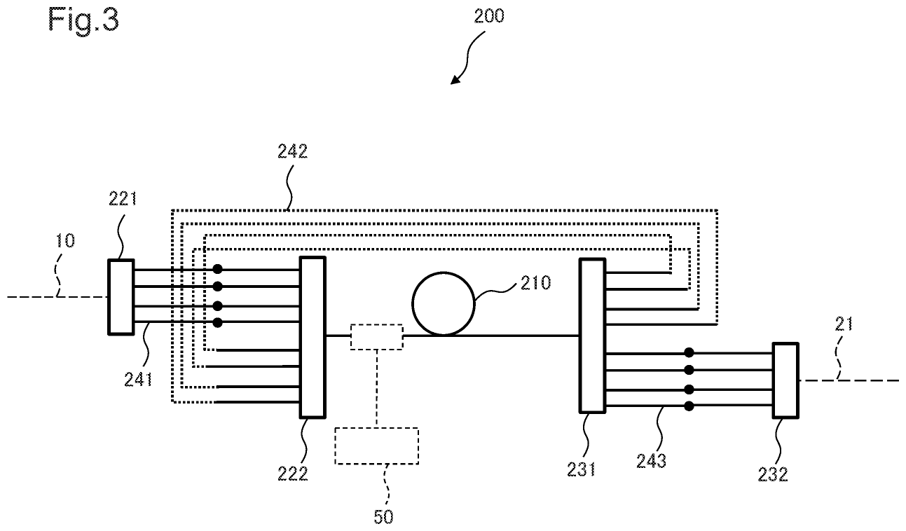

Next, a second example embodiment of the present disclosure is described. FIG. 3 illustrates a configuration of an optical amplification device 200 according to the present example embodiment.

The optical amplification device 200 includes an optical fiber amplification unit (optical fiber amplification means) 210, a first connection unit (first connection means), and a second connection unit (second connection means). Herein, the first connection unit includes a first fan-in/fan-out connection unit (first fan-in/fan-out connection means) 221 and a second fan-in/fan-out connection unit (second fan-in/fan-out connection means) 222. In addition, the second connection unit includes a third fan-in/fan-out connection unit (third fan-in/fan-out connection means) 231 and a fourth fan-in/fan-out connection unit (fourth fan-in/fan-out connection means) 232.

The optical fiber amplification unit 210 includes a plurality of amplification cores. In addition, the first connection unit is configured in such a way as to connect a transmission fiber 10 including a plurality of transmission cores to the optical fiber amplification unit 210. Herein, the number of the plurality of amplification cores is larger than the number of the plurality of transmission cores. As the optical fiber amplification unit 210, a multicore erbium doped fiber (MC-EDF) can be typically used. In addition, the transmission fiber 10 is a multicore optical fiber.

The plurality of amplification cores includes a first amplification core group and a second amplification core group. Then, the first connection unit and the second connection unit are configured in such a way that a plurality of pieces of signal light received by the first connection unit propagate through the first amplification core group and the second amplification core group.

In the optical amplification device 200 according to the present example embodiment, further, the first connection unit and the second connection unit are configured in such a way that a plurality of signal light propagates through the first amplification core group and the second amplification core group in series. Herein, the first connection unit and the second connection unit have a configuration in which a plurality of pieces of signal light propagate through the first amplification core group and the second amplification core group in the same direction in the optical fiber amplification unit 210.

In other words, the optical amplification device 200 has a configuration in which a large number of amplification cores of the optical fiber amplification unit 210 and a small number of transmission cores of the transmission fiber 10 are connected via the first to fourth fan-in/fan-out connection units 221, 222, 231, and 232. Then, the optical amplification device 200 has a configuration in which amplified signal light sent from the third fan-in/fan-out connection unit 231 is returned to an input side, and input to a port to which the transmission fiber 10 of the second fan-in/fan-out connection unit 222 is not connected.

Next, the configuration of an optical amplification device 200 is described in further detail with reference to FIG. 3.

The first fan-in/fan-out connection unit 221 connects each transmission core of the transmission fiber 10 to a first single-core optical fiber 241. The second fan-in/fan-out connection unit 222 connects the first single-core optical fiber 241 to the first amplification core group, and connects the second amplification core group to a second single-core optical fiber 242.

The third fan-in/fan-out connection unit 231 connects the first amplification core group to the second single-core optical fiber 242, and connects the second amplification core group to a third single-core optical fiber 243. Then, the fourth fan-in/fan-out connection unit 232 connects the third single-core optical fiber 243 to each core of a first output side transmission fiber 21.

As described above, in the optical amplification device 200 according to the present example embodiment, the optical fiber amplification unit 210 includes amplification cores larger in number than transmission cores. Thus, even when the number of cores of the transmission fiber 10 is small, it becomes possible to amplify signal light by a large number of amplification cores included in the optical fiber amplification unit 210, and, therefore, power efficiency of excitation light per core can be improved. In other words, the optical amplification device 200 according to the present example embodiment can efficiently amplify signal light in an optical amplification device using a multicore optical fiber.

In addition, according to the optical amplification device 200, a plurality of signal light can propagate through not only the first amplification core group but also the second amplification core group. Thus, since amplification cores larger in number than transmission cores can be used for amplification of signal light, signal light can be efficiently amplified. For example, in a case where the number of amplification cores is equal to or more than twice the number of transmission cores, only equal to or less than half the number of amplification cores contribute to amplification. However, since the optical amplification device 200 according to the present example embodiment can insert amplified signal light into a remaining amplification cores that have not contributed to the first amplification, more amplification cores can be efficiently made use of for amplification of signal light.

Note that, FIG. 3 illustrates, as an example, a case where the transmission multicore fiber 10 includes 4 transmission cores, and the optical fiber amplification unit 210 includes 8 amplification cores, but the numbers of transmission cores and amplification cores are not limited thereto. In addition, a plurality of amplification cores included in the optical fiber amplification unit 210 is assumed to include a first amplification core group and a second amplification core group in the above description, but may further include a third amplification core group.

FIG. 3 also illustrates an excitation light source 50 of the optical fiber amplification unit 210. FIG. 3 illustrates a configuration in which the excitation light source 50 introduces excitation light into the optical fiber amplification unit 210 from a side of the second fan-in/fan-out connection unit 222. However, without being limited thereto, a configuration may be such that excitation light is introduced into the optical fiber amplification unit 210 from a side of the third fan-in/fan-out connection unit 231. In other words, the optical amplification device 200 may be a forward excitation type optical amplification device, or may be a backward excitation type optical amplification device.

In the above description, it is assumed that the first connection unit and the second connection unit are configured in such a way that a plurality of pieces of signal light propagate through the first amplification core group and the second amplification core group in the same direction in the optical fiber amplification unit 210. However, without being limited thereto, the first connection unit and the second connection unit may be assumed to be configured in such a way that a plurality of pieces of signal light propagate through the first amplification core group and the second amplification core group in opposite directions in the optical fiber amplification unit 210.

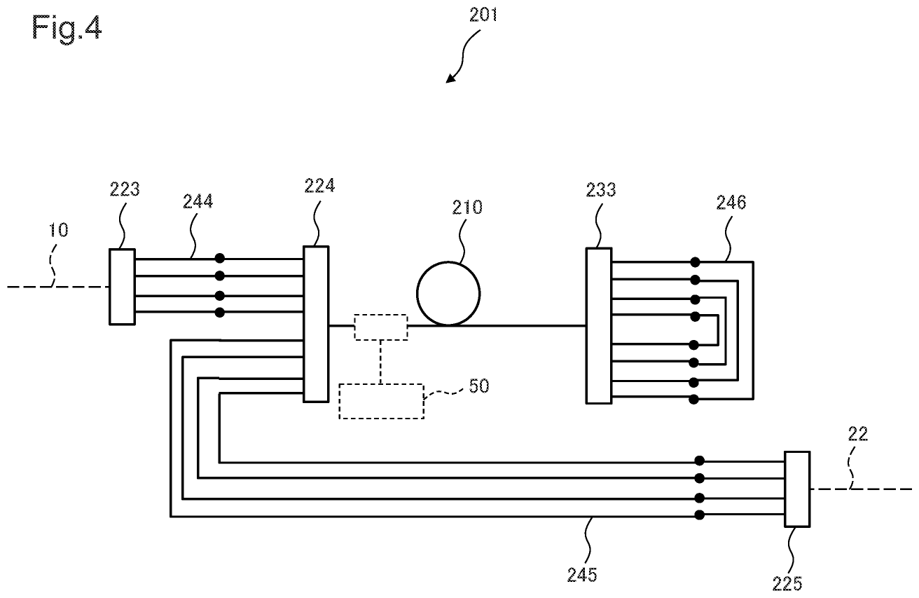

FIG. 4 illustrates a block diagram of an optical amplification device 201 having such a configuration.

The first connection unit included in the optical amplification device 201 includes a fifth fan-in/fan-out connection unit (fifth fan-in/fan-out connection means) 223, a sixth fan-in/fan-out connection unit (sixth fan-in/fan-out connection means) 224, and a seventh fan-in/fan-out connection unit (seventh fan-in/fan-out connection means) 225. In addition, the second connection unit included in the optical amplification device 201 includes an eighth fan-in/fan-out connection unit (eighth fan-in/fan-out connection means) 233.

Herein, the optical amplification device 201 has a configuration in which a large number of amplification cores of the optical fiber amplification unit 210 and a small number of transmission cores of the transmission fiber 10 are connected via the fifth to eighth fan-in/fan-out connection units 223 to 225 and 233. Specifically, the optical amplification device 201 has a configuration in which amplified signal light sent from the eighth fan-in/fan-out connection unit 233 is returned to a port that is not connected to the first amplification core group of the eighth fan-in/fan-out connection unit 233. Then, signal light that has propagated through the optical fiber amplification unit 210 in an opposite direction is configured to be input to a port to which the transmission fiber 10 of the sixth fan-in/fan-out connection unit 224 is not connected.

Next, the configuration of the optical amplification device 201 is described in further detail with reference to FIG. 4.

The fifth fan-in/fan-out connection unit 223 connects each transmission core of the transmission fiber 10 to a fourth single-core optical fiber 244. The sixth fan-in/fan-out connection unit 224 connects the fourth single-core optical fiber 244 to the first amplification core group, and connects the second amplification core group to a fifth single-core optical fiber 245. Then, the seventh fan-in/fan-out connection unit 225 connects the fifth single-core optical fiber 245 to each core of a second output side transmission fiber 22.

The eighth fan-in/fan-out connection unit 233 connects the first amplification core group to a sixth single-core optical fiber 246, and connects the sixth single-core optical fiber 246 to the second amplification core group.

As described above, the optical amplification device 201 has a configuration in which propagation directions of signal light propagating through adjacent cores are opposite directions within the optical fiber amplification unit 210. Thus, crosstalk of signal light in the optical fiber amplification unit 210 can be reduced.

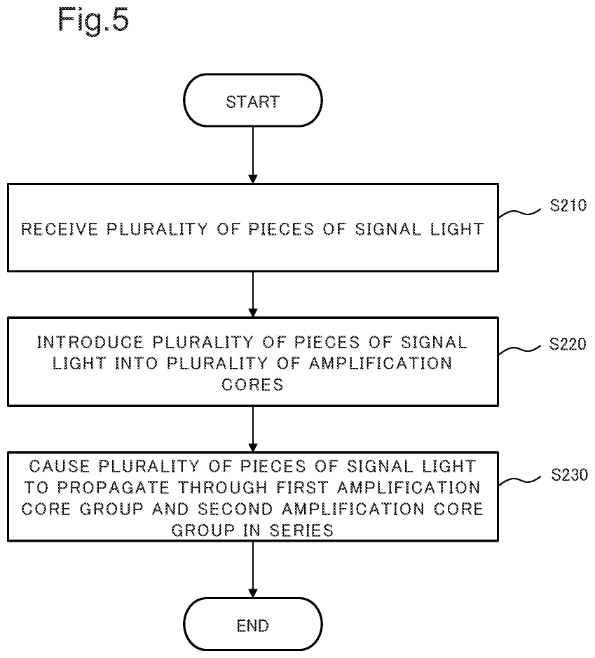

Next, an optical amplification method according to the present example embodiment is described by use of a flowchart illustrated in FIG. 5.

In the optical amplification method according to the present example embodiment, first, a plurality of signal light that have propagated through a plurality of transmission cores are received (step S210). Subsequently, the plurality of pieces of signal light are introduced into a plurality of amplification cores (step S220). Herein, the number of the plurality of amplification cores is larger than the number of the plurality of transmission cores. In addition, the plurality of amplification cores include a first amplification core group and a second amplification core group. Then, the plurality of pieces of signal light are caused to propagate through the first amplification core group and the second amplification core group in series (step S230).

Note that, as for step S210, for example, the first connection means serves as an actor. As for step S220, for example, the first connection means serves as an actor. As for step S230, for example, the first connection means and the second connection means serve as actors.

In this way, since the optical amplification method according to the present example embodiment has a configuration that introduces signal light into amplification cores larger in number than transmission cores, power efficiency of excitation light per core can be improved. In addition, a plurality of pieces of signal light are caused to propagate through not only the first amplification core group but also the second amplification core group. Thus, since amplification cores larger in number than transmission cores can be used for amplification of signal light, signal light can be efficiently amplified.

Herein, propagating a plurality of pieces of signal light through the first amplification core group and the second amplification core group in series includes propagating a plurality of pieces of signal light through the first amplification core group and the second amplification core group in the same direction in a plurality of amplification cores. In addition, propagating a plurality of pieces of signal light through the first amplification core group and the second amplification core group in series includes propagating a plurality of pieces of signal light through the first amplification core group and the second amplification core group in opposite directions in a plurality of adjacent amplification cores.

As described above, the optical amplification devices 200 and 201 and the optical amplification method according to the present example embodiment can efficiently amplify signal light.

### Third Example Embodiment

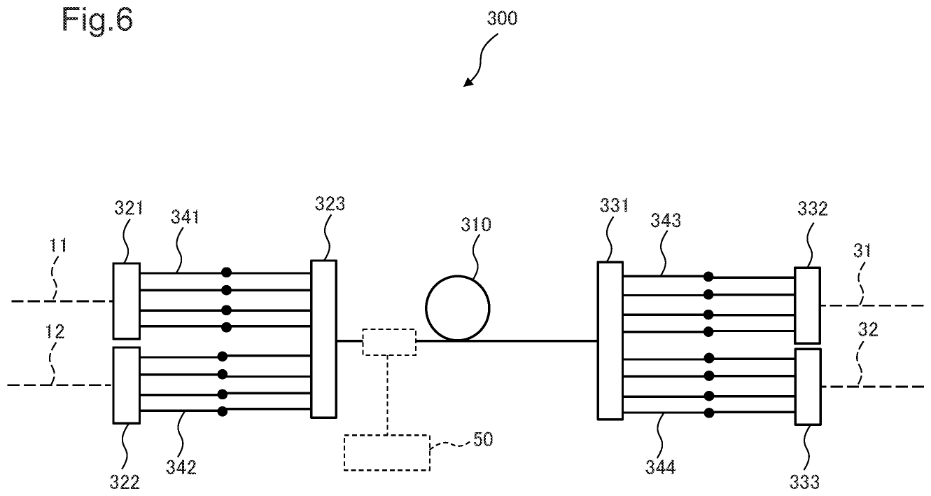

Next, a third example embodiment of the present disclosure is described. FIG. 6 illustrates a configuration of an optical amplification device 300 according to the present example embodiment.

The optical amplification device 300 includes an optical fiber amplification unit (optical fiber amplification means) 310, a first connection unit (first connection means), and a second connection unit (second connection means). Herein, the first connection unit includes a ninth fan-in/fan-out connection unit (ninth fan-in/fan-out connection means) 321, a tenth fan-in/fan-out connection unit (tenth fan-in/fan-out connection means) 322, and an eleventh fan-in/fan-out connection unit (eleventh fan-in/fan-out connection means) 323. In addition, the second connection unit includes a twelfth fan-in/fan-out connection unit (twelfth fan-in/fan-out connection means) 331, a thirteenth fan-in/fan-out connection unit (thirteenth fan-in/fan-out connection means) 332, and a fourteenth fan-in/fan-out connection unit (fourteenth fan-in/fan-out connection means) 333.

The optical fiber amplification unit 310 includes a plurality of amplification cores. Then, the first connection unit is configured in such a way as to connect a first transmission fiber 11 and a second transmission fiber 12 including a plurality of transmission cores to the optical fiber amplification unit 310. Herein, the number of the plurality of amplification cores is larger than the number of the plurality of transmission cores. As the optical fiber amplification unit 310, a multicore erbium doped fiber (MC-EDF) can be typically used.

The plurality of amplification cores includes a first amplification core group and a second amplification core group. Then, the first connection unit and the second connection unit are configured in such a way that a plurality of pieces of signal light received by the first connection unit propagate through the first amplification core group and the second amplification core group.

In this way, in the optical amplification device 300 according to the present example embodiment, the optical fiber amplification unit 310 includes amplification cores larger in number than transmission cores. Thus, even when the numbers of cores of the first transmission fiber 11 and the second transmission fiber 12 are small, it becomes possible to amplify signal light by a large number of amplification cores included in the optical fiber amplification unit 310. As a result, power efficiency of excitation light per core can be improved. In other words, the optical amplification device 300 according to the present example embodiment can efficiently amplify signal light.

In the optical amplification device 300 according to the present example embodiment, further, the first connection unit and the second connection unit are configured in such a way that a plurality of signal light propagates through the first amplification core group and the second amplification core group in parallel.

Next, the configuration of the optical amplification device 300 is described in further detail with reference to FIG. 6.

The ninth fan-in/fan-out connection unit 321 connects each transmission core of the first transmission fiber 11 included in a transmission fiber to a seventh single-core optical fiber 341. The tenth fan-in/fan-out connection unit 322 connects each transmission core of the second transmission fiber 12 included in the transmission fiber to an eighth single-core optical fiber 342. Herein, the first transmission fiber 11 and the second transmission fiber 12 are multicore optical fibers. Then, the eleventh fan-in/fan-out connection unit 323 connects the seventh single-core optical fiber 341 to the first amplification core group, and connects the eighth single-core optical fiber 342 to the second amplification core group.

The twelfth fan-in/fan-out connection unit 331 connects the first amplification core group to a ninth single-core optical fiber 343, and connects the second amplification core group to a tenth single-core optical fiber 344. The thirteenth fan-in/fan-out connection unit 332 connects the ninth single-core optical fiber 343 to each core of a third transmission fiber 31. Then, the fourteenth fan-in/fan-out connection unit 333 connects the tenth single-core optical fiber 344 to each core of a fourth transmission fiber 32.

In other words, the optical amplification device 300 has a configuration in which a large number of amplification cores of the optical fiber amplification unit 310 and a small number of transmission cores of the first transmission fiber 11 and the second transmission fiber 12 are connected via the ninth to fourteenth fan-in/fan-out connection units 321 to 323 and 331 to 333. Then, signal light that has propagated through the first transmission fiber 11 and the second transmission fiber 12 is configured to be amplified by the one optical fiber amplification unit 310.

In this way, according to the optical amplification device 300, since signal light that has propagated through a plurality of transmission multicore fibers can be simultaneously amplified by the one optical fiber amplification unit 310, efficiency increase, size reduction, and space saving of the whole optical amplification system can be accomplished.

In the optical amplification device 300, it can be assumed that the first connection unit and the second connection unit are configured in such a way that a plurality of signal light propagate through the first amplification core group and the second amplification core group in the same direction in the optical fiber amplification unit 310. In other words, each of the ninth fan-in/fan-out connection unit 321 and the tenth fan-in/fan-out connection unit 322 is connected to one of an input side and an output side of signal light. Then, each of the thirteenth fan-in/fan-out connection unit 332 and the fourteenth fan-in/fan-out connection unit 333 can have a configuration that is connected to another of the input side and the output side of the signal light.

Without being limited thereto, the first connection unit and the second connection unit may be configured in such a way that a plurality of pieces of signal light propagate through the first amplification core group and the second amplification core group in opposite directions in the optical fiber amplification unit 310, in the optical amplification device 300. In other words, for example, the ninth fan-in/fan-out connection unit 321 is connected to an input side of signal light, and the thirteenth fan-in/fan-out connection unit 332 is connected to an output side of amplified signal light. In this case, a configuration can be such that the fourteenth fan-in/fan-out connection unit 333 is connected to an input side of signal light, and the tenth fan-in/fan-out connection unit 322 is connected to an output side of amplified signal light.

In this way, in the optical amplification device 300, when a configuration is such that signal light propagates in bi-directional way, the first amplification core group and the second amplification core group can be configured in such a way that signal light propagates in different directions in adjacent amplification cores among amplification cores within the optical fiber amplification unit 310. With such a configuration, crosstalk of signal light in the optical amplification device 300 can be reduced.

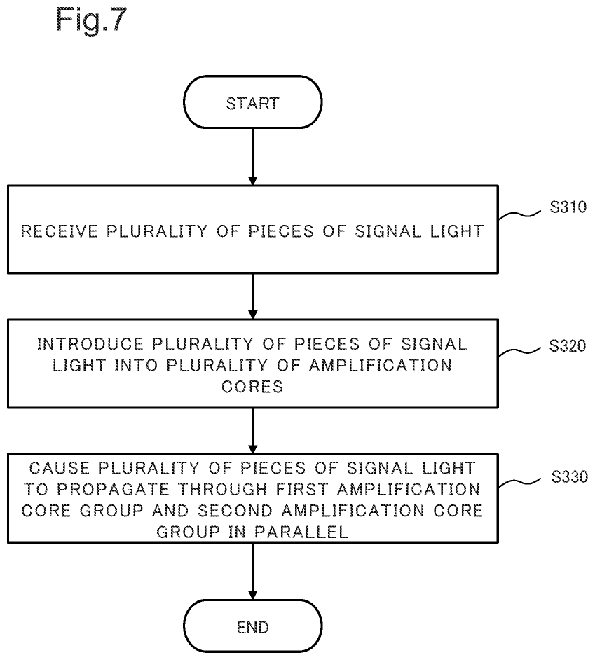

Next, an optical amplification method according to the present example embodiment is described by use of a flowchart illustrated in FIG. 7.

In the optical amplification method according to the present example embodiment, first, a plurality of pieces of signal light that have propagated through a plurality of transmission cores are received (step S310). Subsequently, the plurality of signal light are introduced into a plurality of amplification cores (step S320). Herein, the number of the plurality of amplification cores is larger than the number of the plurality of transmission cores. In addition, the plurality of amplification cores includes a first amplification core group and a second amplification core group. Then, the plurality of pieces of signal light are caused to propagate through the first amplification core group and the second amplification core group in parallel (step S330).

Note that, as for step S310, for example, the first connection means serves as an actor. As for step S320, for example, the first connection means serves as an actor. As for step S330, for example, the first connection means and the second connection means serve as actors.

In this way, since the optical amplification method according to the present example embodiment has a configuration that introduces signal light into amplification cores larger in number than transmission cores, power efficiency of excitation light per core can be improved. Further, it is assumed that a plurality of signal light are caused to propagate through the first amplification core group and the second amplification core group in parallel. Thus, since signal light that has propagated through a plurality of transmission cores can be simultaneously amplified by a plurality of amplification cores, efficiency increase, size reduction, and space saving of the whole optical amplification system can be accomplished.

Herein, propagating a plurality of pieces of signal light through the first amplification core group and the second amplification core group in parallel includes propagating a plurality of pieces of signal light through the first amplification core group and the second amplification core group in the same direction in a plurality of amplification cores. In addition, it may be assumed that propagating a plurality of pieces of signal light through the first amplification core group and the second amplification core group in parallel includes propagating a plurality of pieces of signal light through the first amplification core group and the second amplification core group in opposite directions in a plurality of amplification cores.

As described above, the optical amplification device 300 and the optical amplification method according to the present example embodiment can efficiently amplify signal light in an optical amplification device using a multicore optical fiber.

Some or all of the above-described example embodiments can also be described as, but are not limited to, the following supplementary notes.

### Supplementary Note 1

An optical amplification device including: an optical fiber amplification means including a plurality of amplification cores; a first connection means being connected to one end of the optical fiber amplification means; and a second connection means being connected to another end of the optical fiber amplification means, wherein the first connection means is configured in such a way as to connect a transmission fiber including a plurality of transmission cores to the optical fiber amplification means, and the number of the plurality of amplification cores is larger than the number of the plurality of transmission cores.

### Supplementary Note 2

The optical amplification device according to supplementary note 1, wherein the plurality of amplification cores includes a first amplification core group and a second amplification core group, and the first connection means and the second connection means are configured in such a way that a plurality of pieces of signal light received by the first connection means propagate through the first amplification core group and the second amplification core group.

### Supplementary Note 3

The optical amplification device according to supplementary note 2, wherein the first connection means and the second connection means are configured in such a way that the plurality of signal light propagate through the first amplification core group and the second amplification core group in series.

### Supplementary Note 4

The optical amplification device according to supplementary note 3, wherein the first connection means and the second connection means are configured in such a way that the plurality of pieces of signal light propagate through the first amplification core group and the second amplification core group in the same direction in the optical fiber amplification means.

### Supplementary Note 5

The optical amplification device according to supplementary note 3, wherein the first connection means and the second connection means are configured in such a way that the plurality of pieces of signal light propagate through the first amplification core group and the second amplification core group in opposite directions in the optical fiber amplification means.

### Supplementary Note 6

The optical amplification device according to supplementary note 2, wherein the first connection means and the second connection means are configured in such a way that the plurality of pieces of signal light propagate through the first amplification core group and the second amplification core group in parallel.

### Supplementary Note 7

The optical amplification device according to supplementary note 6, wherein the first connection means and the second connection means are configured in such a way that the plurality of pieces of signal light propagate through the first amplification core group and the second amplification core group in the same direction in the optical fiber amplification means.

### Supplementary Note 8

The optical amplification device according to supplementary note 6, wherein the first connection means and the second connection means are configured in such a way that the plurality of signal light propagate through the first amplification core group and the second amplification core group in opposite directions in the optical fiber amplification means.

### Supplementary Note 9

The optical amplification device according to any one of supplementary notes 1 to 8, wherein the optical fiber amplification means includes a multicore optical fiber including the plurality of amplification cores doped with a rare-earth ion, and a double-clad structure, and the first connection means and the second connection means each includes a fan-in/fan-out connection means.

### Supplementary Note 10

An optical amplification method including: receiving a plurality of signal light propagating through a plurality of transmission cores; and introducing the plurality of signal light into a plurality of amplification cores, wherein the number of the plurality of amplification cores is larger than the number of the plurality of transmission cores, the plurality of amplification cores include a first amplification core group and a second amplification core group, and the plurality of signal light propagates through the first amplification core group and the second amplification core group.

### Supplementary Note 11

The optical amplification method according to supplementary note 10, wherein the causing the plurality of pieces of signal light to propagate through the first amplification core group and the second amplification core group includes causing the plurality of pieces of signal light to propagate through the first amplification core group and the second amplification core group in series.

### Supplementary Note 12

The optical amplification method according to supplementary note 11, wherein the causing the plurality of signal light to propagate through the first amplification core group and the second amplification core group includes causing the plurality of pieces of signal light to propagate through the first amplification core group and the second amplification core group in the same direction in the plurality of amplification cores.

### Supplementary Note 13

The optical amplification method according to supplementary note 11, wherein the causing the plurality of signal light to propagate through the first amplification core group and the second amplification core group includes causing the plurality of pieces of signal light to propagate through the first amplification core group and the second amplification core group in opposite directions in the plurality of amplification cores.

### Supplementary Note 14

The optical amplification method according to supplementary note 10, wherein the causing the plurality of pieces of signal light to propagate through the first amplification core group and the second amplification core group includes causing the plurality of pieces of signal light to propagate through the first amplification core group and the second amplification core group in parallel.

### Supplementary Note 15

The optical amplification method according to supplementary note 14, wherein the causing the plurality of pieces of signal light to propagate through the first amplification core group and the second amplification core group includes causing the plurality of pieces of signal light to propagate through the first amplification core group and the second amplification core group in the same direction in the plurality of amplification cores.

### Supplementary Note 16

The optical amplification method according to supplementary note 14, wherein the causing the plurality of pieces of signal light to propagate through the first amplification core group and the second amplification core group includes causing the plurality of pieces of signal light to propagate through the first amplification core group and the second amplification core group in opposite directions in the plurality of amplification cores.

### Supplementary Note 17

The optical amplification device according to supplementary note 4, wherein the first connection means includes a first fan-in/fan-out connection means and a second fan-in/fan-out connection means, the second connection means includes a third fan-in/fan-out connection means and a fourth fan-in/fan-out connection means, the first fan-in/fan-out connection means connects the transmission core of the transmission fiber to a first single-core optical fiber, the second fan-in/fan-out connection means connects the first single-core optical fiber to the first amplification core group, and connects the second amplification core group to a second single-core optical fiber, the third fan-in/fan-out connection means connects the first amplification core group to the second single-core optical fiber, and connects the second amplification core group to a third single-core optical fiber, and the fourth fan-in/fan-out connection means connects the third single-core optical fiber to a core of a first output side transmission fiber.

### Supplementary Note 18

The optical amplification device according to supplementary note 5, wherein the first connection means includes a fifth fan-in/fan-out connection means, a sixth fan-in/fan-out connection means, and a seventh fan-in/fan-out connection means, the second connection means includes an eighth fan-in/fan-out connection means, the fifth fan-in/fan-out connection means connects the transmission core of the transmission fiber to a fourth single-core optical fiber, the sixth fan-in/fan-out connection means connects the fourth single-core optical fiber to the first amplification core group, and connects the second amplification core group to a fifth single-core optical fiber, the seventh fan-in/fan-out connection means connects the fifth single-core optical fiber to a core of a second output side transmission fiber, and the eighth fan-in/fan-out connection means connects the first amplification core group to a sixth single-core optical fiber, and connects the sixth single-core optical fiber to the second amplification core group.

### Supplementary Note 19

The optical amplification device according to any one of supplementary notes 6 to 8, wherein the first connection means includes a ninth fan-in/fan-out connection means, a tenth fan-in/fan-out connection means, and an eleventh fan-in/fan-out connection means, the second connection means includes a twelfth fan-in/fan-out connection means, a thirteenth fan-in/fan-out connection means, and a fourteenth fan-in/fan-out connection means, the ninth fan-in/fan-out connection means connects the transmission core of a first transmission fiber included in the transmission fiber to a seventh single-core optical fiber, the tenth fan-in/fan-out connection means connects the transmission core of a second transmission fiber included in the transmission fiber to an eighth single-core optical fiber, the eleventh fan-in/fan-out connection means connects the seventh single-core optical fiber to the first amplification core group, and connects the eighth single-core optical fiber to the second amplification core group, the twelfth fan-in/fan-out connection means connects the first amplification core group to a ninth single-core optical fiber, and connects the second amplification core group to a tenth single-core optical fiber, the thirteenth fan-in/fan-out connection means connects the ninth single-core optical fiber to a core of a third transmission fiber, and the fourteenth fan-in/fan-out connection means connects the tenth single-core optical fiber to a core of a fourth transmission fiber.

### Supplementary Note 20

The optical amplification device according to supplementary note 9, wherein the fan-in/fan-out connection means includes one of fiber bundle type fan-in/fan-out, melt-stretching type fan-in/fan-out, space optics type fan-in/fan-out, and flat light waveguide type fan-in/fan-out.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

1. An optical amplification device comprising:
an optical fiber amplification unit including a plurality of amplification cores;
a first connection unit being connected to one end of the optical fiber amplification unit; and
a second connection unit being connected to another end of the optical fiber amplification unit, wherein
the first connection unit is configured in such a way as to connect a transmission fiber including a plurality of transmission cores to the optical fiber amplification unit, and
the number of the plurality of amplification cores is larger than the number of the plurality of transmission cores.

2. The optical amplification device according to claim 1, wherein
the plurality of amplification cores includes a first amplification core group and a second amplification core group, and
the first connection unit and the second connection unit are configured in such a way that a plurality of signal light received by the first connection unit propagate through the first amplification core group and the second amplification core group.

3. The optical amplification device according to claim 2, wherein
the first connection unit and the second connection unit are configured in such a way that the plurality of signal light propagate through the first amplification core group and the second amplification core group in series.

4. The optical amplification device according to claim 3, wherein
the first connection unit and the second connection unit are configured in such a way that the plurality of signal light propagates through the first amplification core group and the second amplification core group in a same direction in the optical fiber amplification unit.

5. The optical amplification device according to claim 3, wherein
the first connection unit and the second connection unit are configured in such a way that the plurality of pieces of signal light propagate through the first amplification core group and the second amplification core group in opposite directions in the optical fiber amplification unit.

6. The optical amplification device according to claim 2, wherein
the first connection unit and the second connection unit are configured in such a way that the plurality of pieces of signal light propagate through the first amplification core group and the second amplification core group in parallel.

7. The optical amplification device according to claim 6, wherein
the first connection unit and the second connection unit are configured in such a way that the plurality of pieces of signal light propagate through the first amplification core group and the second amplification core group in a same direction in the optical fiber amplification unit.

8. The optical amplification device according to claim 6, wherein
the first connection unit and the second connection unit are configured in such a way that the plurality of pieces of signal light propagate through the first amplification core group and the second amplification core group in opposite directions in the optical fiber amplification unit.

9. The optical amplification device according to claim 1, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

10. The optical amplification device according to claim 2, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

11. The optical amplification device according to claim 3, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

12. The optical amplification device according to claim 4, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

13. The optical amplification device according to claim 5, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

14. The optical amplification device according to claim 6, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

15. The optical amplification device according to claim 7, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

16. The optical amplification device according to claim 8, wherein
the optical fiber amplification unit includes a multicore optical fiber including the plurality of amplification cores doped with a rare-earth ion, and a double-clad structure, and
each of the first connection unit and the second connection unit includes fan-in/fan-out connection unit.

17. An optical amplification method comprising:
receiving a plurality of pieces of signal light propagating through a plurality of transmission cores; and
introducing the plurality of pieces of signal light into a plurality of amplification cores, wherein
the number of the plurality of amplification cores is larger than the number of the plurality of transmission cores,
the plurality of amplification cores include a first amplification core group and a second amplification core group, and
the plurality of pieces of signal light are caused to propagate through the first amplification core group and the second amplification core group.
